(19) United States
(12) Patent Application Publication
(10) Pub. No.: US 2011/0154673 A1
(43) Pub. Date: Jun. 30, 2011

(54) Sign board message templates

(76) Inventor: Greg Herth, Oakdale, NY (US)

(21) Appl. No.: 12/925,946

(22) Filed: Nov. 1, 2010

Related U.S. Application Data
(60) Provisional application No. 61/280,185, filed on Oct. 30, 2009.

(51) Int. Cl. G01B 3/14

(52) U.S. Cl. 33/562

(57) ABSTRACT

A pre installed sign board message template is a template tool that can be pre installed between the studs or on the face of the studs by an electrician or other tradesman during the rough in stages of the job. The electrician or tradesman then pulls a wire tail through the templates at the correct location, terminating the wire tail beyond the outer surface the wall stud or ceiling rafters. A notation on the sign board message template directs the wall board (i.e., SHEET ROCK®) panel installer to pull the wire tail through the wall board at a specific location. The signboard templates can be mounted on wall or ceiling studs and on surfaces of any building project to provide visible indicia to assist the tradesman in interpreting a room layout transposed from a blue print or other form of job directions to the actual job work area.

### RELATED APPLICATIONS

This application claims benefit under 35 U.S.C. 119(e) from provisional Application No. 61/280,185 filed Oct. 30, 2009, the entire disclosure of which is incorporated by reference herein.

### FIELD OF THE INVENTION

The present invention is directed to sign board message templates of varying sizes which can assist workers in locating designated locations for electrical wires and other subsequently hidden utility devices, during construction, which devices are ultimately to be hidden behind finished walls.

### BACKGROUND OF THE INVENTION

Many times the electrician, home theatre tradesman, or other wire tradesman are required to leave un-terminated wires or wire tails coiled up inside the wall bays during the rough in stages of the job. As an example, wire tails are left in walls and ceilings for future hi hats, vanity lights etc. The contractor knows the location to install the light but does not know the proper box to install into the wall until a fixture has been purchased. These wire tails are supposed to be pulled out through the sheetrock at designated locations during the installation of the wallboard by the wall board panel (i.e., SHEET ROCK®) panel installer.

More often that not, these wire tails are covered over by the insulation installer. The wall board (i.e., SHEET ROCK®) panel installer does not see these wire tails and in turn, covers the wires up with the wall board, causing much difficulty for the electrician during the finishing stages of the job. Even when the sheet rocker does see these wire tails, more often than not he or she pulls the wire tail out through the wall board at the wrong location.

### OBJECTS OF THE INVENTION

It is therefore an object of the present invention to provide a template for accurate locations of wall fixture outlets having wire tails associated therewith.

It is also an object of the present invention to prevent wire tails for a light fixture outlet from being inadvertently covered over by and insulation installer or a wall board installer.

Other objects which become apparent from the following description of the present invention.

### SUMMARY OF THE INVENTION

The “pre installed sign board message template” is a tool designed to prevent these jobsite issue from occurring. Templates of all shapes and sizes, made from all sorts of material can be pre installed between the studs or on the face of the studs by the electrician or other tradesman during the rough in stages of the job. The electrician or tradesman then pulls the wire tail through the templates at the correct location, in a sense terminating the wire tail beyond the outer surface the wall stud or ceiling rafters. A notation on the sign board message template directs the wall board (i.e., SHEET ROCK®) panel installer to pull the wire tail through the wall board at a specific location. Note the electrical inspector may in force this product during the rough in inspection.

Larger signboard templates can be mounted on the face of the wall or ceiling studs, on all floor, wall or ceiling surfaces of any building project big or small for the purpose of assisting the tradesman in his or her interpretation of a room layout transposed from blue prints or other form of job directions to the actual job work area. An example of a large embodiment for a sign board template for a room layout, but not limited to, would be a kitchen floor plan template showing the location of the cabinetry, lighting, outlets, dishwasher, microwave, range, sink etc. Note that an entire kitchen can now be transposed to the wall or floor on paper/cardboard templates etc. . . . in actual size. The template eliminates “blue print transposing errors” made by the different tradesman. All tradesmen are now working off of the same full scale blueprint diagram on the floor or wall of the room. These templates will also assist the architect, homeowner, general contractor (GC) or anyone else involved in the creative process of designing and installing home kitchens and baths, in homes, high rise apartments, office space layouts etc

Even larger templates can be introduced in cardboard in folding accordion fashion to protect stairs and floors from contractor's dirty feet. Stick on VELCRO® attachments can be applied to the back side of the cardboard to prevent slippage on carpeted stair and hallways. Templates are available in different lengths and widths to accommodate different size hallways, common stairwells to elaborate curving designer stairs etc. All kinds of protective floor coverings that either fold-up or collapse like an accordion or even roll ups fall under this same idea. Pop up shoes and pop up dust pan and broom also fall under this category.

Sign board message templates can come in any shape and size and in any material although cardboard is preferable. This product idea solves many of these issues on the jobsite today but not limited to the following:
1. Wire indicator/locater: the worker brings electrical wire ends (i.e., ROMEX®, “BX”, and “GREENFIELD” electrical wire tails) out beyond face of wall or ceiling studs).
2. A message can be left to the next tradesman in sequence. (i.e. “Bring wire out beyond wall board at this location”).
3. Assist in layout of kitchens, bathrooms etc. . . . (to reduce errors in transition from blue print to actual work area).
4. See the project in actual size before expensive mistakes are made. (Sometimes a homeowner cannot visualize what architect or contractor is talking about without seeing a full size mock-up with the template).
5. Used for advertising a manufacturer or service provider. (It is a great advertising tool during rough in stage of construction before a project is finished).
6. Larger sizes can be provided (Used for protective covering on counters, floors, stairs etc).
7. Worn like shoes in pop up form and even made into tools: saw house, work bench, drafting table, pop up dust pan and broom, and even Dutch style type shoes.

Therefore the sign board message template is an inexpensive tool device (when made from cardboard, plastic, or any suitable material) that can protect an architect, general contractor (GC), home owner, tradesperson, etc. from making costly mistakes in the beginning stages of construction job layout and design, especially in the placement of wire tails of electrical wires for electrical boxes, appliances and fixtures, that might not otherwise come to light until the end or finishing stage of the construction job with wall boards already installed, should the sign board message templates not be used.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a front elevation view of a single sign board message template of the present invention;

FIG. 2 is a perspective view of the sign board message template of the present invention, shown in a folded installation configuration for installing between two studs, wherein the studs have a 16 inch measurement extending between center lines of the studs;

FIG. 3 is a front elevation view of the sign board message template of the present invention, shown with a tradesperson's handwritten instructional message written thereon;

FIG. 4 is a perspective view of the sign board message template of the present invention, shown with two sign board message templates installed in two places between two pairs of studs, with electrical wire tails protruding therethrough;

FIG. 5 is a perspective close up view of the sign board message template of the present invention, shown also with two sign board message templates installed between two adjacent pairs of studs having 16 inch measurement between center lines of each pair of adjacent studs, with electrical wire tails protruding therethrough;

FIG. 6 is a perspective view of an accordion-type foldable multiple unit sign board message template of the present invention, for use in large areas exceeding the size of a single pair of standards studs;

FIG. 7 is a front elevation view of the multiple unit embodiment of FIG. 6 of the present invention, shown laid flat; and,

FIG. 8 is a front elevation view for an alternate embodiment for a full size mock up sign board message template, showing a template for a full size kitchen wall, shown with typical designated locations for electrical wiring for a stove, a stove exhaust, a light fixture over a sink and for a refrigerator, wherein the appliances are shown in dotted lines.

### DETAILED DESCRIPTION OF THE INVENTION

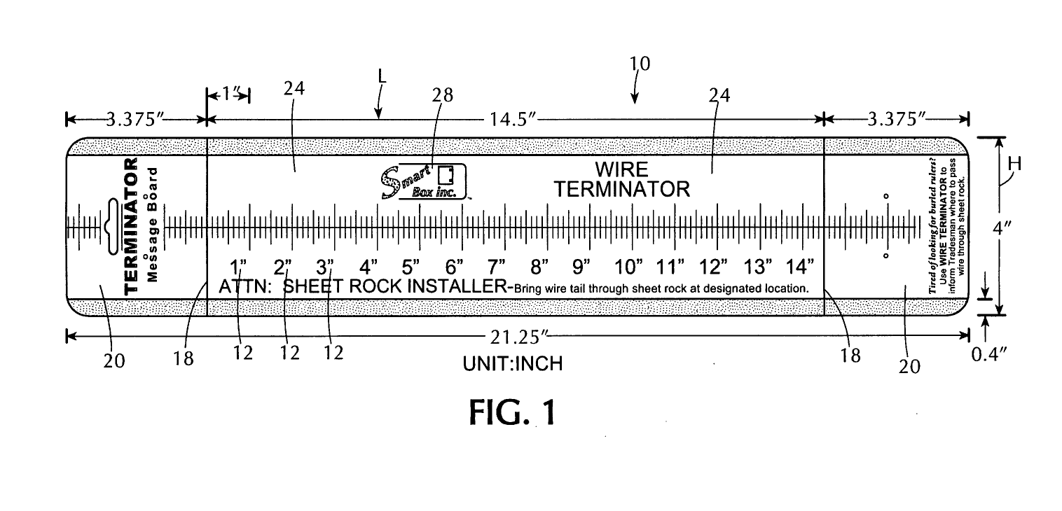

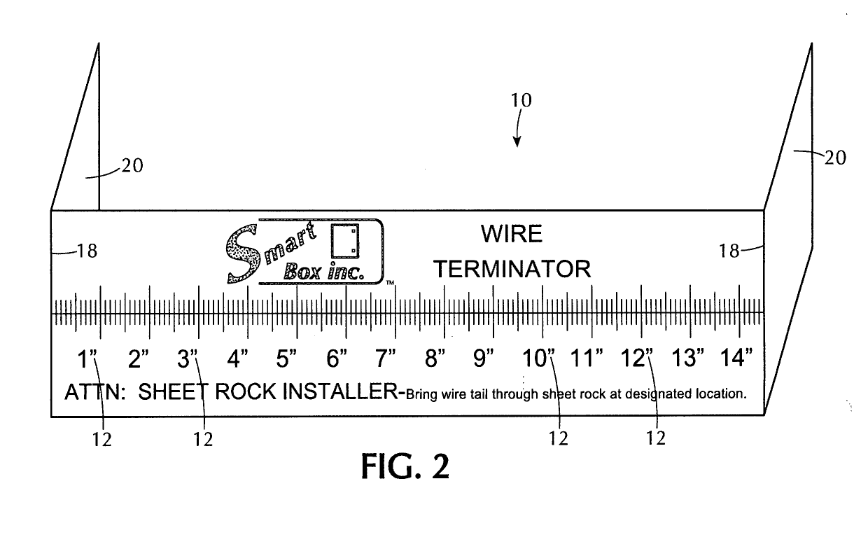

The present invention has broad applications to many technical fields for a variety of articles. For illustrative purposes only, a preferred mode for carrying out the invention is described herein. As shown in FIGS. 1-5, a sign board message template 10 of a predetermined size corresponding to a location 50 at a construction site, such as an area between two adjacent wall studs 52, 54 or 56, 58, for a designated area of a light fixture, a wall, ceiling or floor having electrical wiring and/or utility devices behind finished surfaces of the wall, ceiling or floor, such as locations for electrical wiring associated with lighting, cabinetry or appliances, including lighting fixtures.

For example, as shown in FIGS. 1-5, a pre installed sign board message template designed to prevent jobsite errors from occurring includes a linearly extending marking sign board message template instrument 10 having a predetermined length “L” and height “H” in the predetermined template unit 10. As shown in FIGS. 1-5, the linearly extending marking sign board message template instrument 10 has measuring indicia 12, such as a plurality of predetermined distance markings 12 corresponding to predetermined distances between sets of adjacent construction stud posts 54, 56 or 56, 58, such as “2 by 4” or “2 by 6” lumber wall studs, which have at their exposed wall bearing size an actual width of 1½ inches, which wall studs have a separation distance of 14½ inches between these adjacent studs (measured as 16 inches from the middle of a stud 52 or 56 to the middle of an adjacent stud 54 or 58, wherein the 14½ inch distance between studs becomes 16 inches when the half size ¾ inch measurement from the center of each 1½ width wall stud is taken into account.)

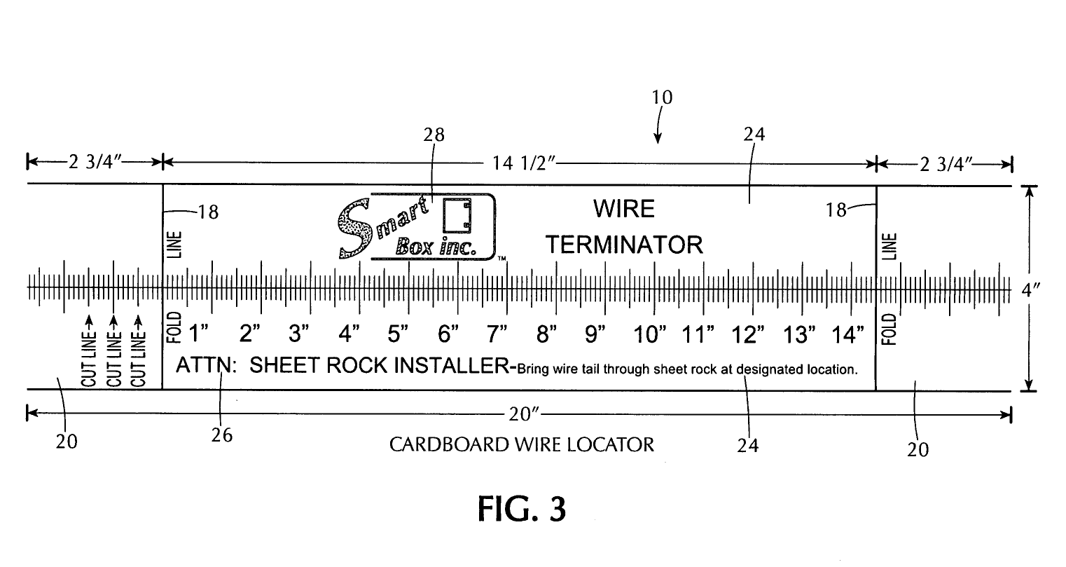

As shown in FIG. 3, to remind subsequent workers, the linearly extending marking sign board message template instrument 10 includes a vacant writing area 24 for user marking of instructions 26 by tradespersons to other workers at a predetermined location 50 of a construction job site. Advertising logos 28 can also be provided.

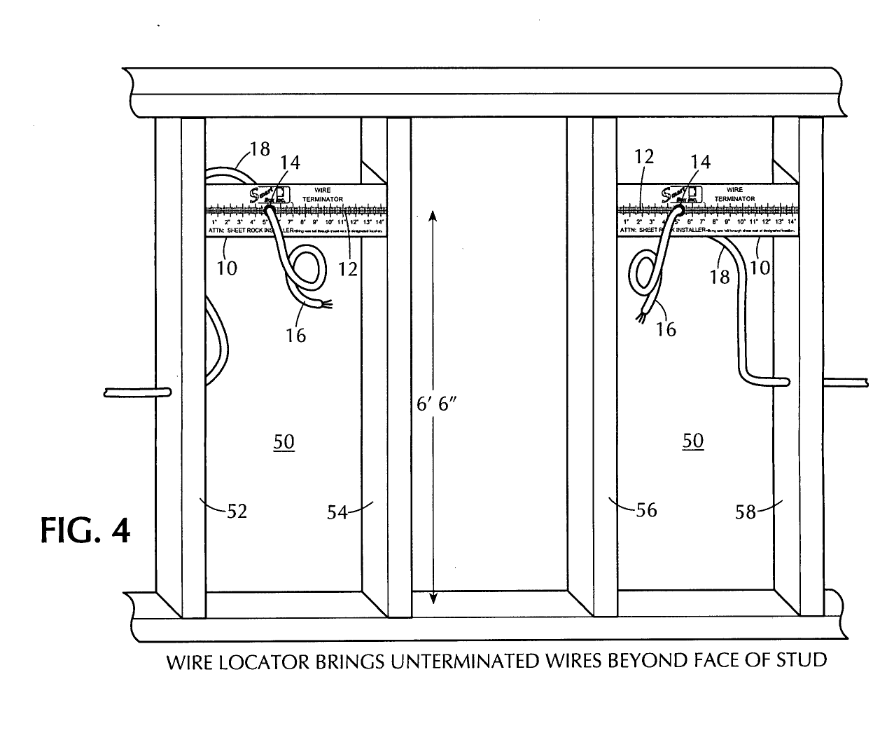

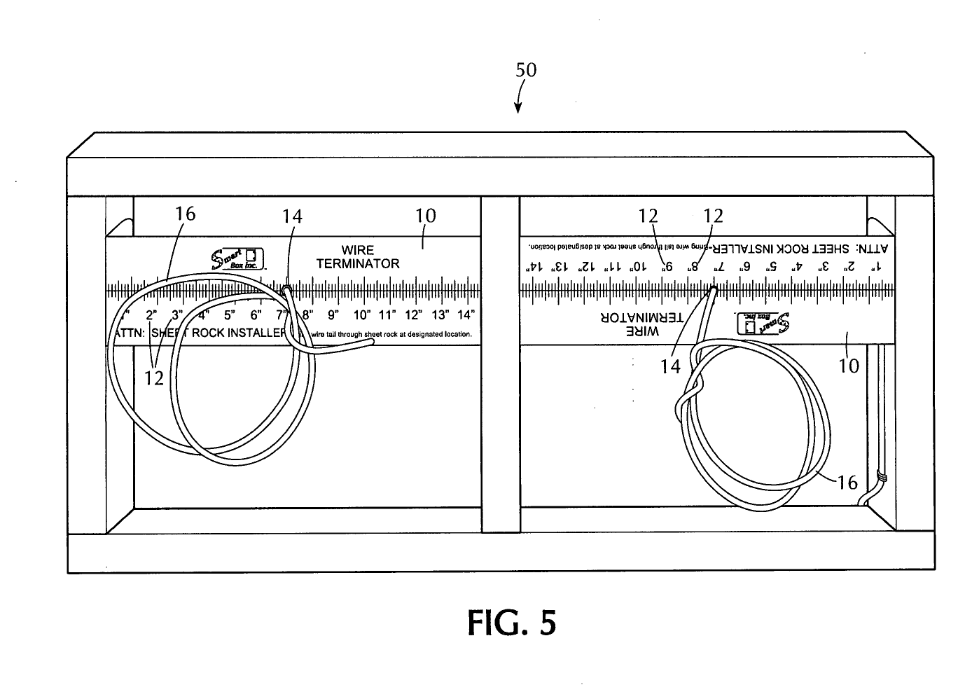

As shown in FIGS. 4 and 5, the linearly extending marking sign board message template instrument 10 can be punctured by a worker at selected locations 14 by an electrical wire tail 16 of an electrical wire cable 18 installed within the confines 50 of a wall, floor or ceiling of a construction site, so that subsequent workers can see the exact location of the wire tails 16 to be used when installing an electrical box, an appliance, a thermostat, a sound amplifier, a visual display screen or a light fixture at the same locations corresponding to wire tail puncture locations 14, on the sign board message template instrument 10 installed between studs at a construction work site 50. It is noted that the punch out puncture locations can be made by the tradesperson using the wire or other sharp implement to puncture the hole 14 in the template 10. Optionally the template instrument 10 can be pre-embossed with rows or columns of selected punch out areas with weakened perforation lines, as are known to those skilled in the art of punch out substrates.

As further shown in FIGS. 1-5, the linearly extending marking sign board message template instrument 10 has fold line indicia 18, such as demarcations indicating pre-fold lines 18 for folding the sign board message template instrument 10 into a predetermined area bounded by construction stud posts 52, 54 or 56, 58. The linearly extending marking sign board message template instrument 10 also has a plurality (such as, for example, a pair) of foldable extensions 20 extending beyond the predetermined distance markings 12 to attach the sign board message template instrument 10 into the aforesaid predetermined area bounded by construction stud posts 52, 54 or 56, 58 in a wall, floor or ceiling of a construction site 50, such as a kitchen, a bathroom or other room in a building, such as a house or commercial building. As also shown in FIG. 3, foldable extensions 20 can have other cut line demarcations, to indicate various cut lines on the extensions 20.

In situations where the tradesperson user wishes to leave the template 10 on the outside of studs 52, 54 or 56,58, the fold line extensions 20 can be optionally used to attach the template 10 to the outside surfaces of studs 52, 54 or 56, 58 by other attachments methods, known to those skilled in the construction field, such as by glue, double sided stick-on tape, VELCRO® hook and loop fasteners, tacks, or the like.

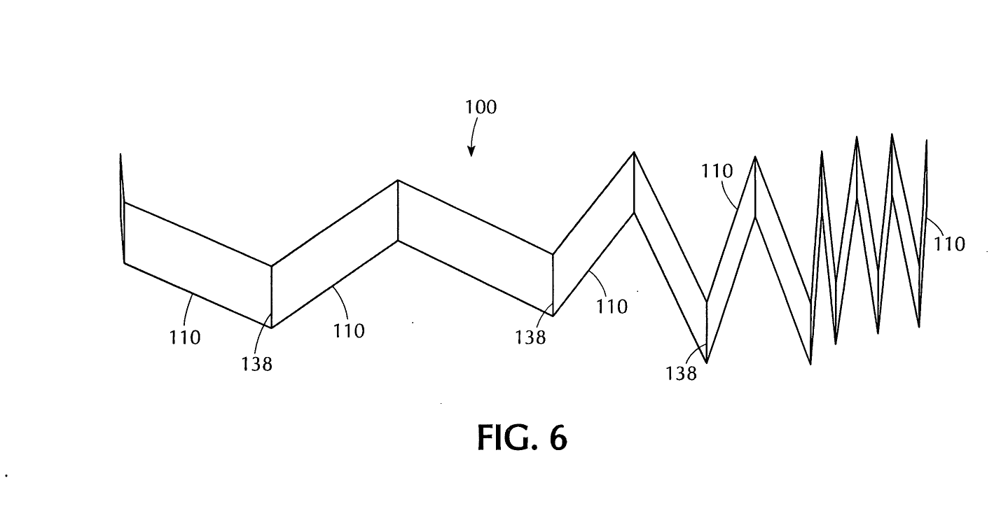

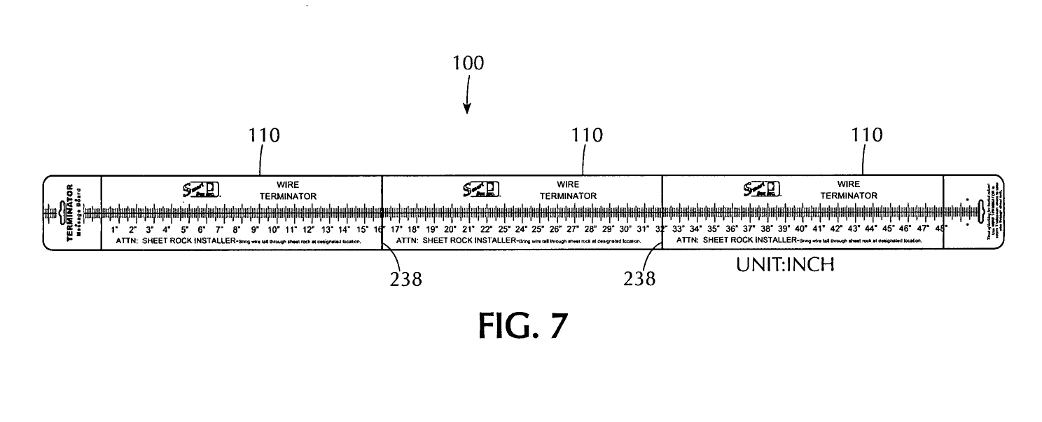

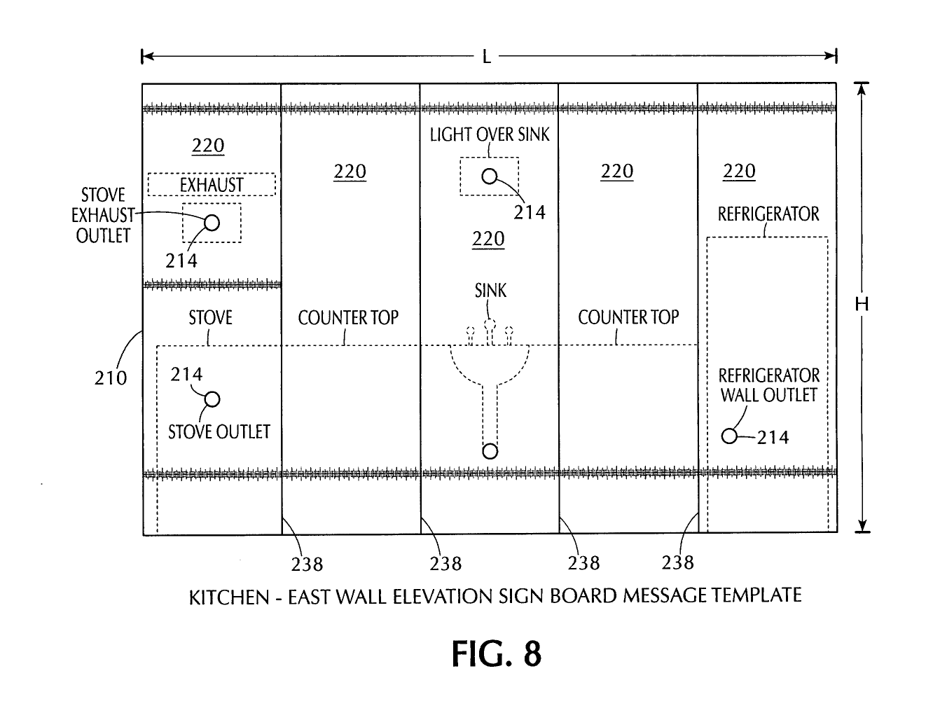

As shown in FIGS. 6 and 7 for a large area, the linearly extending marking sign board message template instrument 100 can be assembled as a plurality of predetermined units 110 hingably joined to each other in a folding accordion configuration by fold lines 138, which unfold to a large area. The large area can have a small predetermined height “H”, so that the sign board message template instrument is long, thin foldable sign board message template instrument 110, or, as shown in FIG. 8, the sign board message template 210 can be configured for large areas, including up to a full size mock up of a ceiling, wall or floor of a construction site, such as shown as sign board message template 210 in FIG. 8, with puncturable locations 214 for wire tails and fold lines 238. For the embodiments of FIGS. 6 and 7 as well as FIG. 8, since the length of the multi-unit template of FIGS. 6 and 7, or the full size mock-up template 210 of FIG. 8, both exceed the standard 14½ distance between studs 52, 54 or 56, 58, multi-unit templates 110 and 210 can also be attached to the outside surfaces of studs 52, 54 or 56, 58 by other attachments methods known to those skilled in the construction field, such as by glue, double sided stick-on tape, VELCRO® hook and loop fasteners, tacks, or the like. While FIG. 8 shows a full size mock-up of a template simulating a two dimensional wall, it is noted that the full size mock-up can simulate multiple surfaces at other designated fold lines, so that the mock-up full size template can include three dimensional mock-ups of the full size of a ceiling with rafters or studs above, joined at the other fold line to reveal a top edge of one or more vertically extending walls with studs located behind the wall, which wall at its respective bottom edge has a further other fold line foldable to reveal a horizontal mockup of a horizontally extending floor, with rafters or studs underneath.

In use, when a predetermined electrical wiring, plumbing or mechanical installation location is determined, and wiring or other components are to be provided at that location, the electrician or tradesperson then pulls a flexible line member, such as the wire tail of the wire or other flexible line, such as a cable, string or rope, through puncture hole 214 of the template units 220 at the correct location 214, thereby terminating the wire tail or other flexible line beyond the future outer surface of the wall stud or ceiling rafters shown in the full size mock up template 210 of FIG. 8, which depicts a full size kitchen wall with marking locations 214 for wire tails of kitchen appliances, such as for a stove, stove exhaust, light or refrigerator. The electrician or other tradesperson can impart a written notation on the expanded size mock up sign board message template 210, which directs subsequent users, such as the wall board panel installer to pull the wire tail or other flexible line through the installed wall board at the specific locations 214 noted on the sign board message template instrument 210.

It is noted that the sign board message templates of the present invention can also be used for location of other construction utility components at designated locations, such as plumbing fixtures, mechanical devices, structural components or cabinetry components are to be located, where a linearly extending flexible line, such as a piece of cable, rope or string can be used in place of the wire tail, and thereby the piece of cable, rope or string penetrates through the designated puncture locations located on the sign board message templates 10, 110 or 210.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A pre installed sign board message template designed to prevent jobsite errors from occurring comprising:
a linearly extending marking sign board message template instrument having a predetermined length and width in a predetermined unit;
said linearly extending marking sign board message template instrument having a plurality of predetermined distance markings corresponding to predetermined distances between construction stud posts;
said linearly extending marking sign board message template instrument being puncturable at selected locations by an electrical wire tail of an electrical wire cable installed within the confines of a wall, floor or ceiling of a construction site,
said linearly extending marking sign board message template instrument having a demarcations indicating pre-fold lines for folding a pair of peripheral edge extensions of said sign board message template instrument into a predetermined area bounded by construction stud posts for attachment therein;
said pair of foldable extensions extending beyond said predetermined distance markings for attaching said template sign board message template instrument into said predetermined area bounded by the construction stud posts;
said linearly extending marking sign board message template instrument having a vacant area for user marking of instructions to other workers at subsequent times at a predetermined location of a construction job site.

2. The linearly extending marking sign board message template instrument as in claim 1 wherein said predetermined unit is a plurality of predetermined units hingably joined to each other in a folding accordion configuration.

3. The linearly extending marking sign board message template instrument as in claim 1 wherein said unit length and width of said unit correspond to a predetermined area of a construction site.

4. The linearly extending marking sign board message template instrument as in claim 1 wherein said predetermined distances are 14½ inch clearance associated with a pair of studs measured from the enter of one stud to the center of an adjacent stud, each said stud being 1½ inches in width.

5. The linearly extending marking sign board message template instrument as in claim 1 wherein said predetermined distances represent a predetermined location of an appliance being installed at the construction site.

6. The linearly extending marking sign board message template instrument as in claim 1 wherein said predetermined distance is a predetermined location of cabinetry at the construction site.

7. The linearly extending marking sign board message template instrument as in claim 1 wherein said predetermined distance is a predetermined location of electrical wiring at the construction site.

8. The linearly extending marking sign board message template instrument as in claim 1 wherein said foldable extensions attach within an area between the pair of wall studs.

9. The linearly extending marking sign board message template instrument as in claim 1 wherein said foldable extensions attach to an area at respective outside edges of the pair of wall studs.

10. The linearly extending marking sign board message template instrument as in claim 2 wherein said linearly extending marking sign board message template instrument is a two dimensional mock-up of a designated construction site.

11. The linearly extending marking sign board message template instrument as in claim 2 wherein said linearly extending marking sign board message template instrument is a three dimensional mock-up of a designated construction site.

12. The sign board message template as in claim 11 wherein said mock-up template simulates multiple surfaces at other designated fold lines, wherein said mock-up full size template includes a full size mock-up of a ceiling with rafters or studs above, joined at the other fold line to reveal a mock-up of a top edge of at least one vertically extending wall with studs located behind the wall, which said vertically extending wall at its respective bottom edge has a further other fold line foldable to reveal a horizontal mockup of a horizontally extending floor, with rafters or studs underneath.

13. The sign board message template as in claim 11 wherein said mock-up template includes a plurality of vertically extending walls extending between said mock-up of said ceiling and said mock-up of said floor.

14. The sign board message template as in claim 2 wherein said sign board message template covers at least a portion of a designated area of a construction site.

15. A pre installed sign board message template designed to prevent jobsite errors from occurring comprising:
a linearly extending marking sign board message template instrument having a predetermined length and width in a predetermined unit;
said linearly extending marking sign board message template instrument having a plurality of predetermined distance markings corresponding to predetermined distances between construction stud posts;
said linearly extending marking sign board message template instrument being puncturable at selected locations by a flexible linearly extending line connected to a construction component location to be installed within the confines of a wall, floor or ceiling of a construction site,
said linearly extending marking sign board message template instrument having a demarcations indicating pre-fold lines for folding a pair of peripheral edge extensions of said sign board message template instrument into a predetermined area bounded by construction stud posts for attachment therein;
said pair of foldable extensions extending beyond said predetermined distance markings for attaching said template sign board message template instrument into said predetermined area bounded by the construction stud posts;
said linearly extending marking sign board message template instrument having a vacant area for user marking of instructions to other workers at subsequent times at a predetermined location of a construction job site.

16. The linearly extending marking sign board message template instrument as in claim 15 wherein said predetermined unit is a plurality of predetermined units hingably joined to each other in a folding accordion configuration.

17. The linearly extending marking sign board message template instrument as in claim 15 wherein said unit length and width of said unit correspond to a predetermined area of a construction site.

18. The linearly extending marking sign board message template instrument as in claim 15 wherein said predetermined distances are 14½ inch clearance associated with a pair of studs measured from the enter of one stud to the center of an adjacent stud, each said stud being 1½ inches in width.

19. The linearly extending marking sign board message template instrument as in claim 15 wherein said predetermined distances represent a predetermined location of an electrical device being installed at the construction site and said flexible line is a wire tail of an electrical wire associated with said electrical device at said predetermined location.

20. The linearly extending marking sign board message template instrument as in claim 15 wherein said predetermined distance is a predetermined location of a plumbing device.

21. The linearly extending marking sign board message template instrument as in claim 15 wherein said predetermined distance is a predetermined location of a mechanical device at the construction site.

23. The linearly extending marking sign board message template instrument as in claim 15 wherein said foldable extensions attach within an area between the pair of wall studs.

24. The linearly extending marking sign board message template instrument as in claim 15 wherein said foldable extensions attach to an area at respective outside edges of the pair of wall studs.

25. The linearly extending marking sign board message template instrument as in claim 16 wherein said linearly extending marking sign board message template instrument is a two dimensional mock-up of a designated construction site.

27. The linearly extending marking sign board message template instrument as in claim 16 wherein said linearly extending marking sign board message template instrument is a three dimensional mock-up of a designated construction site.

28. The sign board message template as in claim 27 wherein said mock-up template simulates multiple surfaces at other designated fold lines, wherein said mock-up full size template includes a full size mock-up of a ceiling with rafters or studs above, joined at the other fold line to reveal a mock-up of a top edge of at least one vertically extending wall with studs located behind the wall, which said vertically extending wall at its respective bottom edge has a further other fold line foldable to reveal a horizontal mockup of a horizontally extending floor, with rafters or studs underneath.

29. The sign board message template as in claim 27 wherein said mock-up template includes a plurality of vertically extending walls extending between said mock-up of said ceiling and said mock-up of said floor.

30. The sign board message template as in claim 16 wherein said sign board message template covers at least a portion of a designated area of a construction site.
